(19) United States
(12) Patent Application Publication
(10) Pub. No.: US 2012/0045562 A1
(43) Pub. Date: Feb. 23, 2012

(54) RICE IMPROVER, COOKED RICE USING SAME, AND PROCESSES FOR PREPARING COOKED RICE

(75) Inventors: Morito Watanabe, Tokyo (JP); Mariko Hotta, Tokyo (JP); Isao Kobayashi, Tokyo (JP); Masaru Goto, Tokyo (JP)

(73) Assignee: J-OIL MILLS, INC., Chuo-ku, Tokyo (JP)

(21) Appl. No.: 13/318,445

(22) PCT Filed: May 11, 2010
(86) PCT No.: PCT/JP2010/003184

§ 371 Date: Nov. 1, 2011

(30) Foreign Application Priority Data
May 15, 2009 (JP) 2009-118168

(51) Int. Cl. A23L 1/182; A23L 1/0522

(52) U.S. Cl. 426/578

(57) ABSTRACT

A rice improver containing a gelatinized product of an acid-treated waxy type starch or a gelatinized product of an oxidation-treated waxy type starch, wherein a cold water solubility of the rice improver in pure water at 25 degrees centigrade is equal to or higher than 50%, wherein a content of a fraction of a granular material sieved over 0.5 mm-opening (32 mesh) sieve in the rice improver is smaller than 5% by weight, and wherein a total of contents of said acid-treated waxy type starch and said oxidation-treated waxy type starch over the whole rice improver is equal to or larger than 50% by weight.

### TECHNICAL FIELD

The present invention relates to a rice improver, a cooked rice employing thereof, and a process for preparing the cooked rice.

### RELATED ART

A rice represented by Japonica rice, which exhibits appropriate gloss and stickiness, is employed for the type of a rice for cook that satisfies the preference of the Japanese citizens. Such gloss and stickiness are mainly resulted from the level of amylopectin content in the rice, and KOSHIHIKARI, SASANISHIKI and the like, containing amylopectin at relatively higher content ratio generally satisfy the taste buds of the Japanese citizens.

On the other hand, along with the advances of the restaurant industry and the take-away food industry in recent years including convenience stores and supermarkets, and various types of takeout lunches, train lunches and the like, preparations of larger amount of rice employing large-scale continuous rice cooking production line are commonly conducted. When the Japonica rice containing higher amount of amylopectin as described above is cooked in such continuous rice cooking production line, higher stickiness due to a dissociation of amylopectin from the rice is exhibited, causing considerable adhesion between rice grains. This causes that a mechanical load produced in the process for spreading rice after the cooking or in the process for forming rice causes crushes of the cooked rice grains into dumpling-like state, easily adhered in the cooking production line and easily adhered onto the forming machine. This also causes an inability for supplying a constant weight of a product or a jam in the forming machine, which, in turn, causes a concern for a decrease in the production yield or for an unstable production. Further, the cooked rice (hereinafter referred to as “cooked rice grain”) containing larger amount of such breaks and crushes induces a stronger pastiness and less grain-feel in the eating-quality, leading to a degradation in the proper quality of the cooked rice grain.

Thus, a fat or an oil is added during a rice process in order to provide improved slidability between the cooked rice grains or between the machine and the cooked rice grains and reduced jam to achieve a stable preparation, or a fat or an oil containing an emulsifying agent is added in order to achieve enhanced dispersibility in the rice cooking process. In addition, a fat or an oil is sprayed in a section of a loosening machine or a forming machine where a jam of the cooked rice is easily caused.

However, an excessively higher adding quantity of the fat or the oil in the rice containing the fat or the oil may cause oily feeling. In addition, when the fat or the oil containing the emulsifying agent is employed, a strange taste resulted from the emulsifying agent may be induced in the rice. Further, surfaces of the rice grains are possibly coated with the oil, decreasing the proper stickiness of the rice. Therefore, in order to eliminate the jam in the preparation process in such large-scale facilities for cooking rice, developments of improvers for obtaining the rice exhibiting higher loosening-ability or the rice exhibiting higher gloss and stickiness with reduced use of the fat or the oil is demanded.

In such circumstances, methods for providing reduced adhesion of the rice during the rice cooking process to achieve improved loosening-ability without employing fat and oil typically include technologies described in Patent Documents 1 to 4 (Japanese Patent Laid-Open No. 2000-41,598, Japanese Patent Laid-Open No. H09-75,022, Japanese Patent Laid-Open No. H07-135,914 and Japanese Patent Laid-Open No. 2000-236,825). These documents disclose that starch-degraded products, which are soluble in a cold water at an ambient temperature represented by dextrin and cyclic starch, are added before the rice cooking process.

In addition, Patent Document 5 (Japanese Patent Laid-Open No. 2004-201,617) also describes a modifier for rice employing both of a starch-degraded product having DE (Dextrose Equivalent) of smaller than 2 and oligosaccharide. In addition, Patent Document 6 (Japanese Patent Laid-Open No. 2008-92,945) also describes a rice modifier obtained by processing starch into granular material to be dispersed uniformly, which exhibits improved gloss and stickiness of the cooked rice grain to provide an advantageous effect for improving eating-quality and flavor.

In addition, Patent Document 7 (Japanese Patent Laid-Open No. 2002-65,184) also describes a manner for providing improved mechanical characteristics of the cooked rice such as release-ability from a kettle, loosening-ability, and the like by adding etherified and/or oxidized modified starch in the rice cooking.

### RELATED ART DOCUMENTS

### Patent Documents

[Patent Document 1] Japanese Patent Laid-Open No. 2000-41,598
[Patent Document 2] Japanese Patent Laid-Open No. H 09-75,022
[Patent Document 3] Japanese Patent Laid-Open No. H 07-135,914
[Patent Document 4] Japanese Patent Laid-Open No. 2000-236,825
[Patent Document 5] Japanese Patent Laid-Open No. 2004-201,617
[Patent Document 6] Japanese Patent Laid-Open No. 2008-92,945
[Patent Document 7] Japanese Patent Laid-Open No. 2002-65,184

### SUMMARY OF THE INVENTION

However, the technologies described in the above-listed Documents contain respective rooms for improvements in the following aspects.

First of all, the dextrin employed in Patent Documents 1 to 4 are starch-degraded products that are soluble in the cold water at the ambient temperature, which are prepared by hydrolyzing starches with an acid or an enzyme, and then bleaching and refining the products, and being dried via various types of drying processes such as a spray drying process, a drum drying process, a freeze dry process and the like. While a certain level of advantageous effect for improving loosening-ability is found by employing by adding such low molecular starch-degraded product to the rice, the resultant loosening-ability effect is not satisfactory.

Further, there are needs to be improved in effects for improving gloss and stickiness, which provide the proper deliciousness of the rice. The reason is that the starch is significantly hydrolyzed with an acid or an enzyme to provide such dextrin, so that amylopectin constituent in the starch is degraded into low molecular compounds. It is supposed that this almost deteriorates the effects for enhancing gloss and stickiness provided by the amylopectin constituents during the rice cooking process, whereby losing the ability to provide preferable gloss and stickiness to the cooked rice when it is employed in the rice.

On the other hand, while the technologies described in Patent Documents 5 and 6 provide improvements in gloss and stickiness of the rice, further improvement is required in the effect for improving the loosening-ability.

The preferable stickiness and the improved loosening-ability are the incompatible phenomena in the rice cooking process, and the reality is that the technology related to a rice improver that provides sufficient loosening-ability suitable in the large-scale rice cooking production line while maintaining the proper stickiness and grain-feel of the cooked rice is not achieved in the conventional technology.

Meanwhile, all the technologies described in Patent Document 7 are made under the assumption that the starch is added immediately before the rice cooking process in the form of powder without substantially gelatinizing. However, in the manners of adding such substances, starch precipitates while the rice is immersed in water in the industrial rice cooking production line, and then the precipitated starch is gelatinized in first in the rice cooking process to provide an increased viscosity of water used for the cooking rice. This results in an obstruction for uniform heat transfer in the rice for cook. Consequently, the rice located in the upper portion within the rice kettle becomes cooked rice having a core and on the other hand, the rice located in the lower portion in the rice kettle becomes the pasty cooked rice with the rice grains being half-crushed. In addition, considerable amount of oblate-like layers are generated in the bottom of the kettle, causing a decrease in the cooked rice production yield, an additional work for cleaning or the like. Thus, the above-described approach of adding starch in a form of powder just after finishing the rice cooking have not yet been put into practical use.

The present invention is, in consideration of the above-described conditions, to provide a rice improver, which is capable of providing cooked rice, which has better quality and is easily loosened, while maintaining the gloss and the stickiness the cooked rice has.

The present invention provides a rice improver containing a gelatinized product of an acid-treated waxy type starch or a gelatinized product of an oxidation-treated waxy type starch, wherein a cold water solubility of the rice improver in pure water at 25 degrees centigrade is equal to or higher than 50%, wherein a content of a granular material sieved over 0.5 mm-opening (32 mesh) sieve in the rice improver is smaller than 5% by weight, and wherein a total of contents of the acid-treated waxy type starch and the oxidation-treated waxy type starch over the whole rice improver is equal to or larger than 50% by weight.

According to the above-described aspect, the improver contains gelatinized products of the acid-treated or the oxidation-treated waxy type starch and also contains an acid-treated or an oxidation-treated waxy type starch at a specific content, and exhibits a specific level of the cold water solubility, so that improved loosening-ability of the cooked rice can be provided while maintaining the gloss and the stickiness of the cooked rice.

The present invention also provides a rice improver containing an acid-treated waxy type starch or an oxidation-treated waxy type starch, wherein a content of a granular material sieved over 0.5 mm-opening (32 mesh) sieve in the rice improver is equal to or larger than 5% by weight, and wherein a total of contents of the acid-treated waxy type starch and the oxidation-treated waxy type starch over the whole rice improver is larger than 80% by weight.

According to the above-described aspect, the improver is a granular material having specific dimensions that contains the acid-treated or the oxidation-treated waxy type starch at a specific content, so that improved loosening-ability of the cooked rice can be provided while maintaining the gloss and the stickiness of the cooked rice.

Further, the present invention provides a process for preparing a cooked rice food, including cooking a rice after adding the aforementioned rice improver according to the present invention at a ratio of equal to or larger than 0.5% by weight and equal to or smaller than 10% by weight over the rice for cook, and a cooked rice food cooked by the process for preparing the cooked rice food.

In addition to above, any arbitrary combination of each of these constitutions or conversions between the categories of the invention such as a process, a device, and the like may also be within the scope of the present invention.

For example, the present invention also includes a method for improving cooked rice by adding the aforementioned rice improver of the present invention at a ratio of equal to or larger than 0.5% by weight and equal to or smaller than 10% by weight over the rice for cook.

Improved loosening-ability of the cooked rice can be provided while maintaining the gloss and the stickiness of the cooked rice by employing the rice improver according to the present invention.

### MODE FOR CARRYING OUT THE INVENTION

The rice improver in the present invention achieves significant effects for improving the quality of the cooked rice by providing solubility in a cold water to an acid-treated or an oxidization-treated waxy type starch that exhibits improved loosening effect and effects for modifying gloss and stickiness, or forming such starch into granular compound, in order to facilitating uniform dispersion in the rice cooking process. The technical significance of the above-described configuration will be described as follows.

The starch employed in the rice improver of the present invention is an acid-treated or an oxidation-treated waxy type starch. The waxy type starch is referred to as a starch containing amylopectin at a rate of substantially 100%, and more specifically, to waxy starches such as waxy cone starch, glutinous rice starch, waxy potato starch and the like. The waxy type starch, referring to here, may be an unprocessed product or may be a processed product, and for example, etherification processing, esterification processing, cross-linking processing, and combinations thereof may be employed.

The above-described waxy type starch is employed as a raw material and is processed with an acid or processed for oxidation to obtain an acid-treated waxy type starch or an oxidation-treated waxy type starch. In this specification, these are also collectively referred to as “acid-treated or oxidation-treated waxy type starch”.

While the process for preparing the acid-treated starch in the present invention is not particularly limited as long as the process is generally known process, a specific process is that a suspension of a starch is made in a dilute solution of an acid such as hydrochloric acid, sulfuric acid or the like at a concentration of 0.5 to 10% over the starch (equivalent to dry weight), and the suspension is continuously stirred at a temperature of 20 to 60 degrees centigrade for 1 to 100 hour(s) to obtain a reduced viscosity of the starch. It is a characteristic feature to provide easy gelatinization with reduced viscosity of the gelatinized suspension by degrading non-crystalline sections of the starch grains by acid.

On the other hand, more specifically, the oxidation-treated starch is a modified starch, obtained by reacting a starch with sodium hypochlorite within an alkaline solution, in which a decrease in the viscosity of the gelatinized solution is caused since carboxyl group or carbonyl group is introduced in molecular of the starch and scission of starch chain is further occurred.

While conditions for the oxidation processing is not particularly limited as long as the conditions are generally known, a specific process is that sodium hypochlorite having available chlorine concentration of about 10% is dropped into a starch suspension, which is prepared to exhibit pH of 8 to 11 and a temperature of 40 to 60 degrees centigrade to continue a reaction for 30 minutes to 4 hours.

The viscosity of an aqueous solution of 30% by weight of the gelatinizing processed products of the acid-treated waxy type starch and the oxidation-treated waxy type starch measured by Brookfield viscometer may be, for example, equal to or higher than 35 cps and equal to or lower than 15,000 cps at 40 degrees centigrade and 30 rpm.

The viscosities of the starch gelatinized solution are reduced for the acid-treated and the oxidation-treated starches, as the reactions are progressed. In view of the balance of the effects for improving the gloss, the stickiness and the loosening-ability of the cooked rice, the viscosity measured, by a Brookfield viscometer (for example, commercially available from TOKYO KEIKI INC), of the acid-treated or the oxidation-treated starch, which is prepared by placing 30% suspension of starch in a hot water bath of 95 degrees centigrade for 30 minutes while being stirred to cause complete gelatinization and then further allowing to stand at 40 degrees centigrade for one hour (Brookfield viscosity of aqueous solution of 30% by weight at 40 degrees centigrade), may be, for example, equal to or higher than 35 cps and equal to or lower than 15,000 cps, preferably equal to or higher than 35 cps and equal to or lower than 10,000 cps, more preferably equal to or higher than 35 cps and equal to or lower than 5,000 cps, and further preferably equal to or higher than 200 cps and equal to or lower than 5,000 cps. Excessively higher viscosity of the starch may provide excessive stickiness to the cooked rice, leading to insufficient loosening effect. On the other hand, excessively lower viscosity of the starch may provide insufficient gloss and stickiness of the cooked rice, and the loosening-ability may not be effectively improved.

In the present Patent Specification, a viscosity measured by a Brookfield viscometer is also alternatively referred to as “Brookfield viscosity”.

In addition to above, both of the acid-treated and the oxidation-treated waxy type starches maintain the crystal structure of the starch, and thus are insoluble in a cold water as they are. On the other hand, dextrin or starch-degraded product is produced by hydrolyzing a starch with an acid or an enzyme until obtaining solubility in a cold water. Thus, the solubility in a cold water of the acid-treated and the oxidation-treated waxy type starches are clearly distinctive from that of the compounds produced by hydrolyzing starches with an acid or an enzyme or the like.

Typical embodiments of the rice improver of the present invention include, more specifically, the following (i) and (ii).

(i) An acid-treated or an oxidation-treated waxy type starch is gelatinized in advance, and the gelatinized product is added to a rice improver.
(ii) A raw material containing an acid-treated or an oxidation-treated waxy type starch is processed into granular form having a specific size to use as a rice improver.

Here, when non-gelatinized starch is added right before the rice cooking process in a form of powder without being processed into granular material, only starch is precipitated on the bottom of the rice kettle during the rice cooking process, which is, in turn, gelatinized to exhibit increased viscosity, disturbing uniform thermal convection. This results that the rice located in the upper section of the interior of the rice kettle becomes a cooked rice having a core. On the other hand, the rice located in the lower portion in the rice kettle becomes pasty cooked rice with the rice grains being half-crushed. In addition, considerable amount of oblate-like layers are generated in the bottom of the rice kettle, causing a decrease in the cooked rice production yield, resulting in burnt deposits, and producing additional work for cleaning or the like.

Thus, the present invention employs that the acid-treated or the oxidation-treated waxy type starch is gelatinized in advance and the gelatinized starch is added, or that the rice improver is processed into granular material having specific size. This can provide improved dispersibility in the rice cooking process.

Rice improvers in the respective embodiments will be described below.

### First Embodiment

A rice improver according to the present embodiment contains a gelatinized product of an acid-treated waxy type starch or a gelatinized product of an oxidation-treated waxy type starch, in which a total of contents of the acid-treated waxy type starch and the oxidation-treated waxy type starch over the whole rice improver is equal to or larger than 50% by weight. Further, a cold water solubility of the rice improver in pure water at 25 degrees centigrade is equal to or higher than 50%, and a content of a granular material sieved over 0.5 mm-opening (32 mesh) sieve in the rice improver is smaller than 5% by weight.

The gelatinizing process, referring to here, indicates a processing for substantially completely breaking down the granular structure of the starch via heating or alkali treatment, and the gelatinized starch is characterized in being substantially soluble in a cold water, unlike the non-gelatinized starch, which is insoluble in a cold water.

A specific method for the gelatinizing processing is that a suspension of a starch is prepared, and is heated to a temperature of not lower than the gelatinizing temperature to completely break down the granular structure of the starch, and then is dried and pulverized with an appropriate method. A conventionally known method may be employed for the drying process, and for example, a drum dry process, an extruder process, a spray dry process and the like may be employed.

Further, the rice improver of the present embodiment may contain a starch obtained by processing the acid-treated waxy type starch or the oxidation-treated waxy type starch to provide a cold water solubility of equal to or higher than 50%.

A cold water solubility is utilized as an indicator representing the gelatinizing condition in the present Patent Specification. The method for measuring the cold water solubility is as follows.

(1) 100 mg of a sample is weighed to place into a test tube.
(2) 10 mL of distilled water (pure water) at 25 degrees centigrade is added to the above-described (1), and then is stirred to disperse it well.
(3) The content in the test tube is transferred to a centrifuge tube having a cap thereon.
(4) A centrifugal separation is conducted (3,000 rpm, 10 minutes), and a quantification of soluble sugar (quantity of total sugar) in a supernatant liquid is conducted via phenol-sulfuric acid colorimetric method.
(5) Cold water solubility (%)=quantity of total sugar in supernatant (mg)/100 (mg)×100.

In the present embodiment, the cold water solubility of the rice improver in pure water of 25 degrees centigrade is equal to or higher than 50%, preferably equal to or higher than 60%, and more preferably equal to or higher than 80%. This can provide effective inhibition for the precipitation of the starch in the rice cooking process to achieve uniform dispersion of the improver, so that variations in the quality of the cooked rice grains just after the cooking can be inhibited. In addition to above, the upper limitation of the cold water solubility of the rice improver is not particularly limited, and thus is equal to or lower than 100%, and for example, it may also be equal to or lower than 95% in view of preventing moisture absorption.

Further, the cold water solubility of the gelatinized product of the acid-treated or the oxidation-treated waxy type starch employed in the present embodiment in pure water of 25 degrees centigrade may be, for example, equal to or higher than 50% and equal to or lower than 100%, preferably equal to or higher than 60% and equal to or lower than 100%, and more preferably equal to or higher than 80% and equal to or lower than 100%. Excessively lower cold water solubility causes a precipitation of the starch in the rice improver in the rice cooking process to occur non-uniform dispersion, causing a concern for creating variations in the quality of the cooked rice grains just after the cooking.

Blending ratio of the starch having higher cold water solubility, that is, the gelatinized product of the acid-treated or the oxidation-treated waxy type starch, for blending in the rice improver, may be suitably adjusted so as to provide a total of a blending ratio of the starch over the rice for cook (equivalent to dry weight) of for example, equal to or larger than 0.5% by weight and equal to or smaller than 10% by weight. This is because excessively larger blending ratio of the gelatinized product of the acid-treated or the oxidation-treated waxy type starch causes an adhesion of excessive starch paste over the surfaces of the cooked rice grains to provide watery cooked rice grains, which may cause unpleasant sensation in the eating-quality. On the other hand, larger blending ratio of the starch in the rice improver exerts sufficient effect as the rice improver with smaller amount of blending ratio, and reduced blending ratio of the starch in the rice improver requires increased amount of addition of the rice improver. In view of influences on the cost and the quality of the cooked rice, it is preferable to add smaller amount of the rice improver. Further, in such point of view, it is also preferable to employ larger blending ratio of the starch having higher cold water solubility in the rice improver as possible.

Further, excessively lower blending ratio of the starch over the rice for cook (equivalent to dry weight) may cause insufficient loosening effect. In such point of view, a total of contents of the acid-treated waxy type starch and the oxidation-treated waxy type starch over the whole rice improver is 50% by weight or more and 100% by weight or less, preferably 75% by weight or more and 100% by weight or less, and more preferably 80% by weight or more and 100% by weight or less.

In addition to above, it is sufficient that at least a portion of the acid-treated or the oxidation-treated waxy type starch is gelatinized in the present embodiment. Besides, the rice improver in the present embodiment may contain a gelatinized product and a non-gelatinized product as the acid-treated or the oxidation-treated waxy type starch. In such case, the blending ratio of the acid-treated or the oxidation-treated waxy type starch over the whole rice improver is a total of the gelatinized product and the non-gelatinized product, and may be prepared to provide, for example, 0.5% by weight or more and 10% by weight or less over the rice (equivalent to dry weight), similarly as described above.

The configuration of the rice improver in the present embodiment essentially consists of powder, and the content of the granular particles over 0.5 mm-opening (32-mesh) sieve according to Japanese Industrial Standard (JIS) is smaller than 5% by weight. Such configuration provides improved dispersion in the kettle during the rice cooking process, so that variations in the quality of the cooked rice in the kettle can be effectively inhibited. In addition to above, the lower limit of the content of the granular material over 0.5 mm-opening (32 mesh) sieve is not particularly limited, and may be equal to or higher than 0% by weight, and more specifically equal to or higher than 1% by weight.

In the present embodiment, the acid-treated or the oxidation-treated waxy type starch is gelatinized in advance, and is then added to the rice improver. This allows providing improved loosening-ability of the cooked rice while maintaining the proper gloss and stickiness of the cooked rice. Further, even in, for example, a large-scale rice cooking production line, the cooked rice, which contains less crush and break, is less pasty and maintains grain-feel, can be stably obtained.

### Second Embodiment

In the present embodiment, a raw material containing an acid-treated or an oxidation-treated waxy type starch is processed into granular form for the use. For example, a rice improver in the present embodiment is essentially configured of an acid-treated or an oxidation-treated waxy type starch, which is processed into granular form.

The granular form in the present embodiment is, more specifically, granular particles containing particles over 0.5 mm-opening (32-mesh) sieve according to JIS at s ratio of equal to or larger than 5% by weight and equal to or smaller than 100% by weight, in which the shape thereof is not limited. In view of the dispersion and the stability for improving cooked rice, it is preferable that the content of the granular material over 0.5 mm-opening (32-mesh) sieve is equal to or larger than 80% by weight.

The rice improver in the present embodiment is obtained by granulating the raw material containing the acid-treated or the oxidation-treated waxy type starch to provide granular particles containing a fraction of the particles over 0.5 mm-opening (32-mesh) sieve at a ratio of equal to or larger than 5% by weight and equal to or smaller than 100% by weight. An apparatus for processing the rice improver into granular form is not particularly limited to any specific apparatus, and general granulator apparatuses such as vibrating, tumbling, stir-mixing, fluidizing, cracking granulators represented by pan granulators, compression molding, wet or dry extruding granulators and the like, may be employed. Among these, in the view point of preparation efficiency and adhesiveness of the grains, an extruding granulator utilizing a twin-screw extruder may be preferably employed. The rice improver, in which at least vicinity of the surface of the particle is gelatinized, is obtained according to such process, so that the dispersibility of the rice improver in the rice cooking process can be further improved. When an extruder is employed for the processing, water is generally added to a raw material containing a starch and the water content is adjusted to 10 to 50% by weight, and then an extruding granulation is conducted at a temperature of 20 to 200 degrees centigrade under the conditions of, for example, a screw rotation of 100 to 1,000 rpm, and a time for thermal processing of 5 to 60 seconds.

The geometry of the rice improver in the present embodiment is not particularly limited, provided that the shape provides easier addition in the rice and faster dissolution during the rice cooking process. Various types of geometries such as spherical geometry, cylindrical geometry, rice grain-like geometry and the like may be obtained by employing different geometries of a discharge opening (die) of a granulator.

The blending ratio of the acid-treated or the oxidation-treated waxy type starch in the granular rice improver according to the present embodiment may be prepared so as to provide the blending ratio of the starch over the rice for cook (equivalent to dry weight) of, for example, 0.5% by weight or larger and 10% by weight or smaller. For example, larger blending ratio of the starch in the rice improver exerts the effect as the rice improver with smaller amount of adding quantity, and reduced blending ratio of the starch in the rice improver requires increased amount of addition of the rice improver. In consideration of influences on the cost and the quality of the cooked rice, it is generally preferable to add smaller amount of the rice improver. In such point of view, it is preferable to employ larger blending ratio of the starch as possible in the rice improver, and a total of contents of the acid-treated or the oxidation-treated waxy type starch over the whole rice improver is larger than 80% by weight and 100% by weight or less, and preferably 90% by weight or more and 100% by weight or less. Excessively lower contents of the acid-treated or the oxidation-treated waxy type starch may fail to exhibit sufficient loosening effect.

While the cold water solubility of the rice improver according to the present embodiment at 25 degrees centigrade is not particularly limited, it may be, for example, 1% or higher in view of further improving the dispersibility, and preferably 5% or higher, and it may be more preferably 50% or higher.

It provides improved loosening-ability of the cooked rice while maintaining the proper gloss and stickiness of the cooked rice in the present embodiment. Further, even in, for example, a large-scale rice cooking production line, the cooked rice, which contains less crush and break, is less pasty and maintains grain-feel, can be stably obtained.

Further, in the present embodiment, the raw material containing the acid-treated or the oxidation-treated waxy type starch is processed into granular form having specific size and the processed product is added during the rice cooking process to achieve improved dispersibility in the rice cooking process, so that, even if such type of starch having lower cold water solubility is employed, improved dispersibility can also be achieved.

The respective rice improvers described in the above-described embodiment may contain various types of foods or additives other than starches.

For example, the rice improver according to the present invention may contain saccharides. Having such configuration, an aging of the starch serving as the improver is reduced, maintaining appropriate gloss and stickiness. Saccharide employed in the present invention is not particularly limited to any specific saccharide provided that the saccharide is presented in the foods, and glucose, sucrose, fructose, maltose, lactose, trehalose, or sugar alcohols such as xylitol, sorbitol, maltitol, erythritol and the like, or invert sugar of saccharide, and further, materials containing reducing sugar, starch syrup mixture, powder starch syrup, and the like, which contain the above-described saccharides as a constituent, may be similarly employed. These saccharides may be employed alone, or in a form of a combination of two or more thereof, and preferably, trehalose alone, or a combination of trehalose and the above-described saccharide, may be employed. Adding quantity of these saccharides over the rice improver is preferably 0.1 to 60 parts by weight over 100 parts by weight of the rice improver, and more preferably 10 to 50 parts by weight.

The rice improver described in the above-described embodiment may contain a fat or an oil. An addition of a fat or oil in the improver provides improved release-ability of the cooked rice from a rice kettle, and improving workability. The fat and oil employed in the present invention is not particularly limited to any specific material provided that it is presented in an ordinary food, and typically include plant oils such as linseed oil, safflower oil, Japanese torreya nuts oil, walnut oil, poppy seed oil, sunflower oil, cotton seed oil, rapeseed oil, soya bean oil, mustard oil, kapok oil, rice bran oil, sesame oil, corn oil, peanut oil, olive oil, camellia oil, tea oil, castor oil, coconut oil, palm oil and the like, and animal fats and oils such as beef fats, fish oils, whale oils, lard, sheep oils and the like. In addition, materials obtained by conducting transesterification of the above-described oils and fats, hardened oils, fractionated oils, and additionally fats or oils obtained by a chemical process or an enzyme process such as medium chain triglycerides (MCT), diglycerides and the like, may also be employed. In addition, so-called dedicated oils for rice cooking, which are oils containing an emulsifying agent and the like for providing enhanced dispersion during the cooking, may also be employed. Adding quantity of these oils and fats over the rice improver is preferably 0.1 to 10 parts by weight and more preferably 0.1 to 8 parts by weight, over 100 parts by weight of the rice improver.

In the above-described embodiment, emulsifying agents such as sucrose fatty acid ester, fatty acid ester and the like, crystalline cellulose, enzymatically hydrolyzed dextrin, indigestible dextrin, cluster dextrin, cyclodextrin, maltooligosaccharide, isomaltooligosaccharide, galacto oligosaccharide and the like, which are generally employed as vehicles or diluting agents, may also be employed as required.

Further, higher dispersibility of the rice improver described in the above-described embodiment may be utilized to contain nutrition functional constituents such as minerals such as calcium, iron and the like, vitamin groups, dietary fibers and the like, kneaded therein, so that a cooked rice having nutrition-supplement function may be easily prepared.

The rice improver of the present invention may be added before the rice for cook is immersed in water or simultaneously with the immersion, or may be added to the immersed rice for cook, and in any cases, the rice for cook may preferably be lightly stirred after adding the improver, in order to uniformly disperse the modifying constituent of the rice improver. Adding quantity of the rice improver over the whole rice for cook is preferably not smaller than 0.5% by weight and not larger than 10% by weight, and more preferably not smaller than 1% by weight and not larger than 5% by weight. Excessively smaller adding quantity may fail to exhibit sufficient effect for improving the cooked rice. On the contrary, excessively larger adding quantity may cause excessively stronger loosening effect for the cooked rice deteriorating the workability such as causing a spinning-around when the cooked rice grains are supplied.

The rice improver of the present invention may be similarly adopted to, in addition to the ordinary rice, the miscellaneous grain crops such as Japanese millet (“hie”), Italian millet (“awa”), barley and the like, or rice-like foods containing nutrition functional constituents such as glucomannan, calcium, iron and the like, kneaded therein, which is processed to form rice-like conformation.

The cooked rice according to the present invention is the rice cooked with an addition of the rice improver at a ratio of equal to or larger than 0.5% by weight and equal to or smaller than 10% by weight over the rice for cook. This allows reducing breaks and crushes of the rice grains caused in the operation of the rice cooking process, so that the cooked rice with better loosening-ability and improved grain-feel can be presented. Therefore, the improver can be utilized to variety of cooked rice foods such as cooked rice grains for lunch boxes, rice balls, cooked rice foods including various foods (“takikomi-gohan”), fried rice, paella, rizotto, rice seasoned with vinegar for sushi (“sushi-meshi”) and the like, which are exhibited in convenience stores and superstores.

The use of the rice improver according to the present invention provides, for example, the following advantageous effects.

(1) It is uniformly dispersed in the rice cooking process to obtain the cooked rice grains with stable quality.
(2) The surface of the rice grain is uniformly coated with a viscous component to provide improved loosening-ability of the rice.
(3) The loosening-ability of the rice is improved to provide reduced crush and break of the rice caused by the device.
(4) The crush and the break of the rice are reduced to provide improved grain-feel in the cooked rice grains, so that delicious rice balls and the cooked rice grains that show smoothness of loosening by chopstick can be presented.
(5) The adding quantity of an oil for cooking rice, which may affect the taste of the cooked rice grains, can be reduced.
(6) The addition of the improver allows reduced viscosity and improved dispersion and convection of water for cooking rice, creating pores in the surface of the cooked rice (“crab pores”), thereby achieving improved gloss, reflection and eating-quality of the cooked rice grains.

### EXAMPLES

Examples of the present invention will be shown in the following, and it is not intended to limit the scope and the spirit of the present invention thereto.

In addition to above, in the following examples, Viscometer BM, commercially available from TOKYO KEIKI INC, was employed for the measurement of the Brookfield viscosity to conduct the measurements at a rotating speed of 30 rpm.

### Text Example 1

### Preparation of Acid-Treated Waxy Cornstarch

170 parts of water was added to 150 parts of waxy cornstarch “AP-Y” (commercially available from J-OIL MILLS, INC., water content 14.2%) to create a suspension. 80 parts of 6% aqueous solution of hydrochloric acid (hydrochloric acid concentration over dried starch; 3.73%) was added thereto while being stirred, and a reaction was continued while being stirred at 40 degrees centigrade for 24 hours. After the reaction, the starch was washed and collected by low-pressure filtration and then dried in the oven processes to obtain an acid-treated waxy cornstarch (Sample 1).

30% slurry of the obtained acid-treated waxy cornstarch was prepared, and the slurry was retained at 95 degrees centigrade for 30 minutes while being stirred and then was retained at 40 degrees centigrade for one hour, and thereafter, the Brookfield viscosity of the slurry was measured. The result was 220 cps. Further, the cold water solubility of the Sample 1 was 0%.

### Text Example 2

### Process for Preparing Oxidation-Treated Waxy Cornstarch

314 parts of water was added to 150 parts of waxy cornstarch “AP-Y” (commercially available from J-OIL MILLS, INC.) to create a suspension. 62 parts of sodium hypochlorite containing available chlorine of 12.1% was added thereto while being stirred, and a reaction was continued while being stirred at 40 degrees centigrade and at pH 8 for 2 hours. After the reaction, the starch was washed and collected by low-pressure filtration and then dried in the oven processes to obtain the oxidation-treated waxy cornstarch. The Brookfield viscosity of the obtained oxidation-treated waxy cornstarch was measured similarly as in the method of Text Example 1. The result was 120 cps. Further, the cold water solubility was 0%.

### Text Example 3

### Process for Preparing Acid-Treated or Oxidation-Treated Waxy Cornstarch Having Different Cold Water Solubility

Slurries of 20% by weight of the acid-treated or the oxidation-treated waxy cornstarch described in Text Examples 1 and 2 were prepared. These slurries were gelatinized by employing an Onlator^{TR} (outlet temperature: 100 degrees centigrade), and then was dried by a drum dryer (surface temperature: 130 degrees centigrade) and was crushed, and then the fractions under the sieve of 0.5 mm-opening (32-mesh) was collected to obtain a gelatinized acid-treated waxy cornstarch (Sample 2) and a gelatinized oxidation-treated waxy cornstarch (Sample 3). The Brookfield viscosities of the obtained gelatinized starches were measured similarly as in the method of Text Example 1. The result was 220 cps for the gelatinized acid-treated waxy cornstarch, and 120 cps for the gelatinized oxidation-treated waxy cornstarch. Further, the cold water solubility of the gelatinized acid-treated waxy cornstarch and the gelatinized oxidation-treated waxy cornstarch were 100%.

### Examples 1 to 5, and Comparative Example 1

### Evaluation of Dispersibility

Mixtures of the Samples 1 to 3 were prepared according to the formulation shown in Table 1, and the fractions under the sieve of 0.5 mm-opening (32-mesh) was collected to prepare rice improvers having different cold water solubility.

The obtained rice improvers were employed to cook rice. First of all, 196 g of rice for cook was added in a rice kettle, and subsequently, 260 mL of water was added, and then was allowed to stand for one hour to cause an immersion. Thereafter, 4 g of each of the rice improvers listed in Table 1 was added (adding 2% over uncooked rice) and was stirred. Thereafter, rice cooking was conducted under the ordinary conditions. The obtained cooked rice was transferred to a vat from the rice cooker without mixing, and then dispersibility of the constituent of the improver was evaluated by a visual inspection. Double circle (∘∘) was assigned when the improver is uniformly dispersed and there was not sense of incongruity at all; Single circle (∘) was assigned when there was hardly sense of incongruity; Triangle (Δ) was assigned when part of the improver was not dissolved in the rice and there was some sense of incongruity; and Cross (x) was assigned when the improver was localized and there was a sense of incongruity, and the results were shown in Table 1.

TABLE 1

| | SAMPLE | | | | | | | | | |
|---|---|---|---|---|---|---|---|---|---|---|
| | | | COLD | | | | | | | |
| | | | WATER | BROOKFIELD | | | | | | COM- |
| | | | SOLUBILITY | VISCOSITY | EXAM- | EXAM- | EXAM- | EXAM- | EXAM- | PARATIVE |
| | | | (%) | (CPS) | PLE 1 | PLE 2 | PLE 3 | PLE 4 | PLE 5 | EXAMPLE 1 |
| FORMULATION | SAMPLE 1 | ACID-TREATED | 0 | 220 | 0 | 0 | 20 | 40 | 50 | 60 |
| (% BY WEIGHT) | | WAXY | | | | | | | | |
| | | CORNSTARCH | | | | | | | | |
| | SAMPLE 2 | GELATINIZED | 100 | 220 | 0 | 100 | 80 | 60 | 50 | 40 |
| | | ACID-TREATED | | | | | | | | |
| | | WAXY | | | | | | | | |
| | | CORNSTARCH | | | | | | | | |
| | SAMPLE 3 | GELATINIZED | 100 | 120 | 100 | 0 | 0 | 0 | 0 | 0 |
| | | OXIDATION- | | | | | | | | |
| | | TREATED | | | | | | | | |
| | | WAXY | | | | | | | | |
| | | CORNSTARCH | | | | | | | | |

| | | | | | | |
|---|---|---|---|---|---|---|
| COLD WATER SOLUBILITY OF RICE IMPROVER (%) | 100 | 100 | 80 | 60 | 50 | 40 |
| FRACTION OVER 0.5 MM-OPENING (32-MESH) SIEVE (%) | 0 | 0 | 0 | 0 | 0 | 0 |
| CONTENT OF ACID-TREATED OR THE OXIDATION-TREATED WAXY | 100 | 100 | 100 | 100 | 100 | 100 |
| CORNSTARCH IN RICE IMPROVER (%) | | | | | | |
| DISPERSIBILITY | ◯◯ | ◯◯ | ◯◯ | ◯ | Δ | X |

As shown in Table 1, when the acid-treated or the oxidation-treated starch is added to the rice for cook in a form of powder, the addition of the rice improver having excessively lower cold water solubility caused poor dispersibility of the constituent of the improver in the rice cooking process, so that gelatinized solution was accumulated on the bottom of the kettle, resulting in burnt deposits. On the other hand, the use of the starch which was gelatinized to enhance the cold water solubility achieved the uniform dispersion of its constituent in the rice cooking process.

### Examples 6 to 11

The gelatinized acid-treated waxy cornstarch (Sample 2) was added according to the formulation shown in Table 2 over the uncooked rice, and then the cooking rice was carried out. The cooked rice obtained was cooled with a vacuum cooler, and sensory evaluations related to the loosening-ability of the cooked rice and the pastiness of the cooked rice grain just after the cooling were conducted by 10 panelist persons. A cooked rice cooked without adding a rice improver was employed for Control Example. The results are shown in Table 2. The criteria for evaluation in Table 2 are as follows.

### Loosening-Ability

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Pastiness of the Cooked Rice Grain

Double circle (∘∘): No pastiness in the cooked rice grains, and no sense of incongruity;

Single circle (∘): Almost no pastiness in the cooked rice grains, and no sense of incongruity;

Triangle (Δ): Somewhat pasty cooked rice grains; and

Cross (x): Pasty cooked rice grains.

TABLE 2

| | EXAMPLE 6 | EXAMPLE 7 | EXAMPLE 8 | EXAMPLE 9 | EXAMPLE 10 | EXAMPLE 11 |
|---|---|---|---|---|---|---|
| UNCOOKED RICE (g) | 200 | 200 | 200 | 200 | 200 | 200 |
| SAMPLE 2 | 20 | 10 | 8 | 4 | 2 | 1 |
| (GELATINIZED ACID-TREATED | | | | | | |
| WAXY CORNSTARCH) (g) | | | | | | |
| ADDING QUANTITY OF | 10 | 5 | 4 | 2 | 1 | 0.5 |
| RICE IMPROVER OVER | | | | | | |
| UNCOOKED RICE (%) | | | | | | |
| LOOSENING-ABILITY | ◯◯ | ◯◯ | ◯◯ | ◯◯ | ◯ | Δ |
| PASTINESS OF COOKED | Δ | ◯ | ◯ | ◯◯ | ◯◯ | ◯◯ |
| RICE GRAIN | | | | | | |

The loosening-ability was stably improved when the adding quantity of the rice improver of equal to or larger than 0.5% by weight over the uncooked rice was employed in Table 2. On the other hand, when the adding quantity of the rice improver of equal to or smaller than 10% by weight over the uncooked rice was employed, the fluidity of the viscous component on the surfaces of the cooked rice grains was limited to an appropriate level, so that the sense of incongruity due to the pasty eating-quality was stably reduced.

### Examples 12 to 16 and Comparative Examples 2 and 3

The rice improvers (“Samples” in Table 3) containing the gelatinized acid-treated waxy cornstarch described in Table 1 (Sample 2) and cold water-soluble dextrin FZ-100 (commercially available from J-OIL MILLS, Inc.) at the rates shown in Table 3 were prepared, and each of the Samples was added according to the formulation shown in Table 3 over the uncooked rice, and then the cooking rice was carried out. The cooked rice obtained was cooled with a vacuum cooler, and sensory evaluations related to the loosening-ability of the cooked rice and the pastiness, gloss and stickiness of the cooked rice grain just after the cooling were conducted by 10 panelist persons. A cooked rice cooked without adding a rice improver was employed for Control Example.

The results are shown in Table 3. The criteria for evaluation in Table 3 are as follows.

### Loosening-Ability

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Pastiness of the Cooked Rice Grains

Double circle (∘∘): No pastiness in the cooked rice grains, and no sense of incongruity;

Single circle (∘): Almost no pastiness in the cooked rice grains, and no sense of incongruity;

Triangle (Δ): Somewhat pasty cooked rice grains; and

Cross (x): Pasty cooked rice grains.

### Gloss

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Stickiness

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

TABLE 3

| | | EXAM- | EXAM- | EXAM- | EXAM- | EXAMPLE | COMPARATIVE | COMPARATIVE |
|---|---|---|---|---|---|---|---|---|
| | | PLE 12 | PLE 13 | PLE 14 | PLE 15 | 16 | EXAMPLE 2 | EXAMPLE 3 |
| FORMULATIONS | SAMPLE 2 | 4 | 3.6 | 3.2 | 3 | 2 | 1.8 | 1 |
| OF SAMPLES | (GELATINIZED ACID-TREATED | | | | | | | |
| | WAXY CORNSTARCH) (g) | | | | | | | |
| | DEXTRIN (g) | 0 | 0.4 | 0.8 | 1 | 2 | 2.2 | 9 |
| | RATE OF ACID-TREATED WAXY | 100 | 90 | 80 | 75 | 50 | 45 | 10 |
| | CORNSTARCH (% by weight) | | | | | | | |

| | | | | | | | |
|---|---|---|---|---|---|---|---|
| UNCOOKED RICE (g) | 200 | 200 | 200 | 200 | 200 | 200 | 200 |
| ADDING QUANTITY OF SAMPLE OVER UNCOOKED | 4 | 4 | 4 | 4 | 4 | 4 | 10 |
| RICE (g) | | | | | | | |
| LOOSENING-ABILITY | ◯◯ | ◯◯ | ◯ | Δ | Δ | X | X |
| PASTINESS OF COOKED RICE GRAIN | ◯◯ | ◯◯ | ◯ | Δ | Δ | X | X |
| GLOSS | ◯◯ | ◯◯ | ◯◯ | ◯ | Δ | X | X |
| STICKINESS | ◯◯ | ◯◯ | ◯ | ◯ | Δ | X | X |

It was confirmed that improved loosening-ability, gloss, and stickiness were obtained according to table 3, when the rate of the acid-treated waxy cornstarch in the rice improver is equal to or larger than 50%, and preferably equal to or larger than 75%.

### Text Example 4

### Difference on the Loosening-Ability by Viscosity of Acid-treated Starch

As shown in Table 4, acid-treated starches exhibiting various viscosities were prepared similarly as in the method of Text Example 1 by employing different respective conditions for reactions in the acid-treatment. The measurement results of the Brookfield viscosities of the obtained starches are also shown in Table 4.

TABLE 4

| | SLURRY | | REACTION | HYDROCHLORIC ACID | BROOKFIELD |
|---|---|---|---|---|---|
| | CONCENTRATION | REACTION TIME | TEMPERATURE | CONCENTRATION | VISCOSITY |
| | (%) | (HR) | (° C.) | (%) | (CPS) |
| SAMPLE 4 | 30 | 6 | 40 | 0.85 | 17400 |
| SAMPLE 5 | 30 | 15 | 40 | 0.84 | 14800 |
| SAMPLE 6 | 35 | 2 | 40 | 3.70 | 5900 |
| SAMPLE 7 | 32 | 15 | 40 | 3.72 | 1100 |
| SAMPLE 8 | 32 | 30 | 40 | 3.73 | 83 |
| SAMPLE 9 | 32 | 72 | 40 | 3.75 | 30 |

### Text Example 5

The acid-treated starches of Samples 4 to 9 (Table 4) and Sample 1 were gelatinized similarly as in the method of Text Example 3 to prepare the gelatinized acid-treated starches exhibiting enhanced cold water solubility.

### Examples 17 to 23 and Comparative Example 4

The gelatinized acid-treated starch obtained in Text Example 5 was added in the rice cooking process similarly as in the method of Example 1 to carry out cooking rice. A cooked rice cooked without adding a rice improver was employed for Control Example. Further, the acid-treated waxy cornstarch was replaced with cold water-soluble dextrin FZ-100 (commercially available from J-OIL MILLS, Inc.) to present Comparative Example. The cooked rice obtained was cooled with a vacuum cooler, and sensory evaluations related to the loosening-ability and the eating-quality of the cooked rice just after the cooling were conducted by 10 panelist persons.

The results are shown in Table 5.

### Loosening-Ability

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Eating-Quality

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

TABLE 5

| | | BROOKFIELD | EXAM- | EXAM- | EXAM- | EXAM- | EXAM- | | | COM- |
|---|---|---|---|---|---|---|---|---|---|---|
| | | VISCOSITY | PLE | PLE | PLE | PLE | PLE | EXAMPLE | EXAMPLE | PARATIVE |
| | | (CPS) | 17 | 18 | 19 | 20 | 21 | 22 | 23 | EXAMPLE 4 |
| FORMULATIONS | GELATINIZED | 17400 | 100 | 0 | 0 | 0 | 0 | 0 | 0 | 0 |
| OF SAMPLES | PRODUCT | | | | | | | | | |
| (%) | OF SAMPLE 4 | | | | | | | | | |
| | GELATINIZED | 14800 | 0 | 100 | 0 | 0 | 0 | 0 | 0 | 0 |
| | PRODUCT | | | | | | | | | |
| | OF SAMPLE 5 | | | | | | | | | |
| | GELATINIZED | 5900 | 0 | 0 | 100 | 0 | 0 | 0 | 0 | 0 |
| | PRODUCT | | | | | | | | | |
| | OF SAMPLE 6 | | | | | | | | | |
| | GELATINIZED | 1100 | 0 | 0 | 0 | 100 | 0 | 0 | 0 | 0 |
| | PRODUCT | | | | | | | | | |
| | OF SAMPLE 7 | | | | | | | | | |
| | GELATINIZED | 220 | 0 | 0 | 0 | 0 | 100 | 0 | 0 | 0 |
| | PRODUCT | | | | | | | | | |
| | OF SAMPLE 1 | | | | | | | | | |
| | GELATINIZED | 83 | 0 | 0 | 0 | 0 | 0 | 100 | 0 | 0 |
| | PRODUCT | | | | | | | | | |
| | OF SAMPLE 8 | | | | | | | | | |
| | GELATINIZED | 30 | 0 | 0 | 0 | 0 | 0 | 0 | 100 | 0 |
| | PRODUCT | | | | | | | | | |
| | OF SAMPLE 9 | | | | | | | | | |
| | DEXTRIN | 20 | 0 | 0 | 0 | 0 | 0 | 0 | 0 | 100 |

| | | | | | | | | |
|---|---|---|---|---|---|---|---|---|
| COLD WATER SOLUBILITY OF RICE IMPROVER | 100 | 100 | 100 | 100 | 100 | 100 | 100 | 100 |
| (%) | | | | | | | | |
| FRACTION OVER 0.5 MM-OPENING (32-MESH) | 0 | 0 | 0 | 0 | 0 | 0 | 0 | 0 |
| SIEVE (%) | | | | | | | | |
| CONTENT OF ACID-TREATED | 100 | 100 | 100 | 100 | 100 | 100 | 100 | 0 |
| STARCH (%) | | | | | | | | |
| LOOSENING-ABILITY | Δ | ◯ | ◯ | ◯◯ | ◯◯ | ◯◯ | Δ | X |
| EATING-QUALITY | Δ | Δ | ◯ | ◯◯ | ◯◯ | ◯ | Δ | X |

According to Table 5, no effect for improving the loosening-ability was obtained with the starch-degraded products such as dextrin, which is highly degraded and exhibits lower Brookfield viscosity (Comparative Example 4).

### Examples 24 to 30

Samples 4 to 9 described in table 4 and Sample 1 were employed, and materials were mixed according to the formulations in Table 6, and a twin-screw extruder (“KEI-45”, commercially available from Kowa Kogyo Co., Ltd.) was employed to conduct an extruding processing under the conditions of a barrel temperature of 100 degrees centigrade, an outlet temperature of 60 degrees centigrade, hydration of 33%, and a screw rotation of 200 rpm. The obtained granular material was dried (at 40 degrees centigrade, for 24 hours) with a drying machine so as to provide a final moisture of equal to or lower than 10%, and then was passed through the sieve of 0.5 mm-opening (32-mesh), where the fraction on the sieve was collected to obtain granular rice improvers.

The rice improver thus obtained was added in the rice cooking process under the conditions similar to that in Example 1 to carry out cooking rice. A cooked rice cooked without adding a rice improver was employed for Control Example. The cooked rice obtained was cooled with a vacuum cooler, and sensory evaluations related to the loosening-ability and the eating-quality of the cooked rice just after the cooling were conducted by 10 panelist persons, similarly as in Example 17.

The results are shown in Table 6.

TABLE 6

| | | BROOKFIELD | | | | | | | |
|---|---|---|---|---|---|---|---|---|---|
| | | VISCOSITY | EXAMPLE | EXAMPLE | EXAMPLE | EXAMPLE | EXAMPLE | EXAMPLE | EXAMPLE |
| | | (CPS) | 24 | 25 | 26 | 27 | 28 | 29 | 30 |
| FORMU- | SAMPLE 4 | 17400 | 95 | 0 | 0 | 0 | 0 | 0 | 0 |
| LATIONS OF | SAMPLE 5 | 14800 | 0 | 95 | 0 | 0 | 0 | 0 | 0 |
| SAMPLES (%) | SAMPLE 6 | 5900 | 0 | 0 | 95 | 0 | 0 | 0 | 0 |
| | SAMPLE 7 | 1100 | 0 | 0 | 0 | 100 | 0 | 0 | 0 |
| | SAMPLE 1 | 220 | 0 | 0 | 0 | 0 | 95 | 0 | 0 |
| | SAMPLE 8 | 83 | 0 | 0 | 0 | 0 | 0 | 95 | 0 |
| | SAMPLE 9 | 30 | 0 | 0 | 0 | 0 | 0 | 0 | 95 |
| | RICE OIL | | 5 | 5 | 5 | 0 | 5 | 5 | 5 |

| | | | | | | | |
|---|---|---|---|---|---|---|---|
| FRACTION OVER 0.5 MM-OPENING | 100 | 100 | 100 | 100 | 100 | 100 | 100 |
| (32-MESH) SIEVE (%) | | | | | | | |
| CONTENT OF ACID-TREATED | 95 | 95 | 95 | 100 | 95 | 95 | 95 |
| STARCH (%) | | | | | | | |
| LOOSENING-ABILITY | Δ | ◯ | ◯ | ◯◯ | ◯◯ | ◯◯ | Δ |
| EATING-QUALITY | Δ | Δ | ◯ | ◯◯ | ◯◯ | ◯ | Δ |

### Examples 31 to 34, and Comparative Examples 5 to 7

Granular rice improvers were obtained by employing Sample 1 and cold water-soluble dextrin FZ-100 (commercially available from J-OIL MILLS, Inc.) with a twin-screw extruder according to formulations of Table 7 similarly as in Example 24.

The rice improver thus obtained was added in the rice cooking process under the conditions similar to that in Example 1 to carry out cooking rice. A cooked rice cooked without adding a rice improver was employed for Control Example. The cooked rice obtained was cooled with a vacuum cooler, and sensory evaluations related to the loosening-ability, gloss and stickiness of the cooked rice just after the cooling were conducted by 10 panelist persons. The results are shown in Table 7.

### Loosening-Ability

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Gloss

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Stickiness

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

TABLE 7

| | | | | | | | COM- | COM- |
|---|---|---|---|---|---|---|---|---|
| | | EXAMPLE | EXAMPLE | EXAMPLE | EXAMPLE | COMPARATIVE | PARATIVE | PARATIVE |
| | | 31 | 32 | 33 | 34 | EXAMPLE 5 | EXAMPLE 6 | EXAMPLE 7 |
| FORMULATIONS | ACID-TREATED | 100 | 95 | 90 | 85 | 80 | 75 | 40 |
| OF SAMPLES | WAXY | | | | | | | |
| (%) | CORNSTARCH | | | | | | | |
| | (SAMPLE 1) | | | | | | | |
| | DEXTRIN | 0 | 5 | 10 | 15 | 20 | 25 | 60 |

| | | | | | | | |
|---|---|---|---|---|---|---|---|
| FRACTION OVER 0.5 MM-OPENING | 100 | 100 | 100 | 100 | 100 | 100 | 100 |
| (32-MESH) SIEVE (%) | | | | | | | |
| CONTENT OF ACID-TREATED | 100 | 95 | 90 | 85 | 80 | 75 | 40 |
| WAXY CORNSTARCH (%) | | | | | | | |
| LOOSENING-ABILITY | ◯◯ | ◯◯ | ◯ | Δ | X | X | X |
| GLOSS | ◯◯ | ◯ | ◯ | ◯ | Δ | Δ | X |
| STICKINESS | ◯◯ | ◯◯ | ◯ | ◯ | Δ | X | X |

According to Table 7, better results on the loosening-ability, the gloss and the stickiness were obtained for the granular rice improver containing the acid-treated waxy cornstarch at a rate of larger than 80%.

### Example 35 and Comparative Example 8

An etherified waxy cornstarch having additional hydroxypropyl group was immersed in an acidic aqueous solution according to the method described in Japanese Patent Laid-Open No. 2002-65,184 (Patent Document 7) to conduct an acid-treatment, obtaining a modified starch (acid-treated etherified waxy cornstarch).

The cold water solubility of the obtained modified starch was 0%.

Further, 500 g of 5% aqueous solution of the obtained modified starch was heated for 30 minutes at 95 degrees centigrade while being stirred and was allowed to stand for being cooled for 30 minutes, and then viscosity was measured with a Brookfield viscometer, and the resultant viscosity was 100 cps.

In addition, a Brookfield viscosity of 30% aqueous solution of the obtained modified starch was measured similarly as in Test Experiment 1, and the resultant viscosity was 18,500 cps.

In addition to above, the content of the fraction of the granular material of the obtained modified starch over the 0.5 mm-opening (32 mesh) sieve was smaller than 5% by weight.

The obtained modified starch was added in the rice cooking process similarly as in Example 2 to prepare the cooked rice, and the dispersibility, the loosening-ability and the eating-quality thereof were evaluated (Comparative Example 8). The results are shown in Table 8.

Further, such modified starch was gelatinized similarly as in Text Example 3 to achieve the cold water solubility of 100%, and then was added to the rice for cook and then the rice was cooked, and the dispersibility, the loosening-ability and the eating-quality were evaluated (Example 35). The results are shown in table 8.

TABLE 8

| | | COMPARATIVE | |
|---|---|---|---|
| | EXAMPLE 2 | EXAMPLE 8 | EXAMPLE 35 |
| STARCH | GELATINIZED ACID- | ETHERIFIED ACID- | GELATINIZED |
| | TREATED WAXY | TREATED WAXY | ETHERIFIED ACID- |
| | CORNSTARCH | CORNSTARCH | TREATED WAXY |
| | | | CORNSTARCH |
| DISPERSIBILITY | ∘∘ | x | ∘∘ |
| LOOSENING-ABILITY | ∘∘ | x | Δ |
| EATING-QUALITY | ∘∘ | x | Δ |

According to Table 8, in Comparative Example 8, where the rice containing the acid-treated etherified waxy cornstarch in non-gelatinized state with lower cold water solubility added in a form of powder was cooked, the improvement constituent was not dispersed uniformly over the cooked rice grains due to poor dispersibility.

### Examples 36 and 37

According to formulations shown in Table 9, the granular material of the gelatinized acid-treated waxy cornstarch described in Table 1 (Sample 2) or the acid-treated waxy cornstarch described in Table 6 (Example 28) was added to a rice-like food-containing rice containing a rice-like food prepared by granulating glucomannan (trade name: Mannan Hikari^{TR}, commercially available from Otsuka Foods Co., Ltd.) at a rate of 2% over the dry weight of the rice-like food-containing rice, and then the rice was cooked. A cooked rice-like food-containing rice cooked without adding a rice improver was employed for Control Example. The cooked rice obtained was cooled with a vacuum cooler, and sensory evaluations related to the stickiness and eating-quality of the cooked rice just after the cooling were conducted by 10 panelist persons. The results are shown in Table 9.

### Stickiness

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

### Eating-Quality

Double circle (∘∘): Distinctly preferable as compared with Control Example;

Single circle (∘): Preferable as compared with Control Example;

Triangle (Δ): Somewhat preferable as compared with Control Example; and

Cross (x): No significant difference from Control Example.

TABLE 9

| | | | | CONTROL |
|---|---|---|---|---|
| | | EXAMPLE 36 | EXAMPLE 37 | EXAMPLE |
| FORMULATIONS | RICE | 160 | 160 | 160 |
| (g) | RICE-LIKE FOOD CONTAINING GLUCOMANNAN | 40 | 40 | 40 |
| | GELATINIZED ACID-TREATED WAXY | 4 | 0 | 0 |
| | CORNSTARCH (SAMPLE 2) | | | |
| | GRANULAR MATERIAL OF GELATINIZED | 0 | 4 | 0 |
| | ACID TREATED WAXY CORNSTARCH | | | |
| | WATER | 265 | 265 | 260 |
| EVALUATION | STICKINESS | ∘∘ | ∘∘ | x |
| RESULTS | EATING-QUALIT | ∘ | ∘∘ | x |

### Examples 38 and 39

According to formulations shown in Table 10, the granular material of the gelatinized acid-treated waxy cornstarch described in Table 1 (Sample 2) or the acid-treated waxy cornstarch described in Table 6 (Example 28) was added to a rolled barley-containing rice containing commercially available rolled barley at a rate of 2% over the dry weight of the rolled barley-containing rice, and then the rice was cooked. A rolled barley-containing rice cooked without adding a rice improver was employed for Control Example. The cooked rice obtained was cooled with a vacuum cooler, and sensory evaluations related to the stickiness and eating-quality of the cooked rice just after the cooling were conducted by 10 panelist persons, similarly as in Examples 36 and 37. The results are shown in table 10.

TABLE 10

| | | | | CONTROL |
|---|---|---|---|---|
| | | EXAMPLE 38 | EXAMPLE 39 | EXAMPLE |
| FORMULATIONS | RICE | 180 | 180 | 180 |
| (g) | ROLLED BARLEY | 20 | 20 | 20 |
| | GELATINIZED ACID-TREATED WAXY | 4 | 0 | 0 |
| | CORNSTARCH (SAMPLE 2) | | | |
| | GRANULAR MATERIAL OF GELATINIZED | 0 | 4 | 0 |
| | ACID TREATED WAXY CORNSTARCH | | | |
| | WATER | 265 | 265 | 260 |
| EVALUATION | STICKINESS | ∘∘ | ∘∘ | x |
| RESULTS | EATING-QUALIT | ∘ | ∘∘ | x |

1. A rice improver containing a gelatinized product of an acid-treated waxy type starch or a gelatinized product of an oxidation-treated waxy type starch,
wherein a cold water solubility of the rice improver in pure water at 25 degrees centigrade is equal to or higher than 50%,
wherein a content of a fraction of a granular material sieved over 0.5 mm-opening (32 mesh) sieve in the rice improver is smaller than 5% by weight,
wherein a total of contents of said acid-treated waxy type starch and said oxidation-treated waxy type starch over the whole rice improver is equal to or larger than 50% by weight, and
wherein viscosity of an aqueous solution of the gelatinized products of said acid-treated waxy type starch and said oxidation-treated waxy type starch contained at 30% by weight measured by a Brookfield viscometer is equal to or higher than 30 cps and equal to or lower than 17,400 cps at 40 degrees centigrade and 30 rpm.

2. The rice improver as set forth in claim 1, wherein a total of contents of said acid-treated waxy type starch and said oxidation-treated waxy type starch over the whole rice improver is equal to or larger than 75% by weight.

3. The rice improver as set forth in claim 1, wherein viscosity of an aqueous solution of the gelatinized products of said acid-treated waxy type starch and said oxidation-treated waxy type starch contained at 30% by weight measured by a Brookfield viscometer is equal to or higher than 35 cps and equal to or lower than 15,000 cps at 40 degrees centigrade and 30 rpm.

4. A rice improver containing an acid-treated waxy type starch or an oxidation-treated waxy type starch,
wherein a content of a fraction of a granular material sieved over 0.5 mm-opening (32 mesh) sieve in the rice improver is equal to or larger than 5% by weight, and
wherein a total of contents of said acid-treated waxy type starch and said oxidation-treated waxy type starch over the whole rice improver is larger than 80% by weight, and
wherein said acid-treated waxy type starch and said oxidation-treated waxy type starch are an acid-treated waxy type starch and an oxidation-treated waxy type starch, which exhibit equal to or higher than 30 cps and equal to or lower than 17,400 cps at 40 degrees centigrade and 30 rpm as a viscosity of an aqueous solution of gelatinized products contained at 30% by weight measured by a Brookfield viscometer, when said acid-treated waxy type starch and said oxidation-treated waxy type starch are gelatinized.

5. The rice improver as set forth in claim 4, wherein viscosity of an aqueous solution of gelatinized products of said acid-treated waxy type starch and said oxidation-treated waxy type starch contained at 30% by weight measured by Brookfield viscometer is equal to or higher than 35 cps and equal to or lower than 15,000 cps at 40 degrees centigrade and 30 rpm.

6. A process for preparing a cooked rice food, including cooking a rice after adding the rice improver as set forth in claim 1 at a ratio of equal to or larger than 0.5% by weight and equal to or smaller than 10% by weight over the rice for cook.

7. A cooked rice food cooked by the process as set forth in claim 6.

8. A process for preparing a cooked rice food, including cooking a rice after adding the rice improver as set forth in claim 4 at a ratio of equal to or larger than 0.5 by weight and equal to or smaller than 10% by weight over the rice for cook.

9. A cooked rice food cooked by the process as set forth in claim 8.
